(19) United States
(12) Patent Application Publication
(10) Pub. No.: US 2002/0156766 A1
(43) Pub. Date: Oct. 24, 2002

(54) Communication setting support method and communication setting support system

(75) Inventors: Yoshinobu Nakamura, Osaka (JP); Yoshio Ozawa, Osaka (JP)

Correspondence Address: DARBY & DARBY P.C., POST OFFICE BOX 5257, NEW YORK, NY, 10150-5257, US

(73) Assignee: SANYO ELECTRIC CO., LTD., OSAKA (JP)

(21) Appl. No.: 10/108,752

(22) Filed: Mar. 27, 2002

(30) Foreign Application Priority Data
Mar. 29, 2001 (JP) 2001-97669

(51) Int. Cl. G06F 7/00

(52) U.S. Cl. 707/1

(57) ABSTRACT

A controller 1 reads first identification information preset for devices 2, and stores the read first identification information. Each device 2 accepts unique second identification information for identifying the device, and outputs the accepted second identification information to the controller 1. The controller 1 stores the outputted second identification information in association with the stored corresponding first identification information. With this configuration, it is possible to prevent errors in setting device names for the devices and reduce the administrator's burden.

### BACKGROUND OF THE INVENTION

1. Field of the Invention

The present invention relates to a communication setting support method and a communication setting support system, for supporting communication setting between a plurality of devices and a controller which controls the devices.

2. Description of Related Art

In a facility such as a shop and a building, a plurality of devices such as showcases equipped with a cooling system, air-conditioning systems and lighting equipment are installed. The facility is further provided with a controller which controls these devices in a centralized manner. Since the controller controls on/off or temperature of each of the devices, it is necessary to identify and control the respective devices individually.

FIG. 1 is an explanatory view showing a conventional device identifying method. As shown in FIG. 1, a controller 100 is connected to devices 200 such as showcases through a communication cable 107. Each device 200 has an unrepresented DIP switch. An administrator uses the DIP switch to set a unique value for each device 200. The values set by the DIP switches are read by the controller 100, and then stored in a storage unit 105 and displayed on a display unit 104. FIG. 2 is an explanatory view showing the record contents in the storage unit 105. As shown in FIG. 2, the read DIP switch codes are stored in association with corresponding connecting port numbers, respectively. Meanwhile, the device name of each device 200 and control conditions such as temperature condition of each device 200 are stored in association with a corresponding DIP switch code.

Since a DIP switch code is usually configured as a matrix of a plurality of digits, it is difficult for the administrator to identify each device from the DIP switch code by intuition. Therefore, the administrator approaches the controller 100 and inputs all suitable device names for the devices 200 through an input unit 103 of the controller 100. Subsequently, with reference to the inputted device names, the administrator inputs the control conditions for the devices 200 through the input unit 103. Note that the contents stored in the storage unit 105 are displayed on the display unit 104.

In the conventional method, however, the administrator needs to move to each of the devices in a facility, such as a shop or a building, set the DIP switches, record the set values and device names on paper or the like, and then approach the controller 100 to input the device names recorded on the paper in association with the corresponding DIP switch codes through the input unit 103. Hence, there is a possibility that, for a device 200, the name of other device will be mistakenly set during the process. If the name of other device is mistakenly set, then control conditions are set for a wrong device, which gives adverse effects on the goods in the facility. In particular, since the types and the number of devices installed in a facility have increased in recent years, the above-mentioned problem has become conspicuous.

### BRIEF SUMMARY OF THE INVENTION

The present invention has been made with the aim of solving the above problem, and it is an object thereof to provide a communication setting support method and a communication setting support system, capable of preventing errors in the settings of device names given to the devices installed in a facility and of reducing the administrator's burden by providing the devices with first identification information such as MAC (Media Access Control) addresses and by inputting unique second identification information for identifying each of the devices through the devices.

Another object of the present invention is to provide a communication setting support method and a communication setting support system, capable of further reducing the administrator's burden by using a portable information terminal to input the device names.

A communication setting support method and a communication setting support system according to the present invention is a method for supporting communication setting between a plurality of devices and a controller which controls the devices. In the communication setting support method, the controller reads first identification information preset for each of the devices, and stores the read first identification information. The devices accept unique second identification information for identifying the respective devices, and output the accepted second identification information to the controller. The outputted second identification information is stored in association with the stored corresponding first identification by the controller.

A communication setting support system according to the present invention is composed of a plurality of devices and a controller which controls the devices, and supports communication setting between the devices and the controller. In the communication setting support system, the controller comprises means for reading first identification information preset for each of the devices, and means for storing the read first identification information. The devices comprise means for accepting unique second identification information for identifying the respective devices, and means for outputting the accepted second identification information to the controller. The controller further comprises means for storing the outputted second identification information in association with the stored corresponding first identification information.

According to the above-described invention, the controller has a plug-and-play function, and reads the first identification information such as an MAC address preset for each device. The controller stores all the read first identification information about the devices. Meanwhile, each device accepts unique second identification information for identifying the device. The devices output the accepted second identification information to the controller. The outputted second identification information is stored in the controller, in association with the stored corresponding first identification information. With the invention configured as described above, it is possible to prevent confusion in setting the names of the devices by the administrator and significantly reduce the administrator's burden for setting.

In another communication setting support method according to the present invention, the controller reads first identification information preset for each of the devices, and stores the read first identification information. A portable terminal apparatus connected to the controller through a communicating network accepts unique second identification information for identifying a device. A device accepts third identification information for distinguishing one device from other devices, and outputs the accepted third identification information to the controller. Thereafter, the portable terminal apparatus transmits the accepted second identification information to the controller. The transmitted second identification information is stored in the controller, in association with the stored corresponding first identification information.

Another communication setting support system according to the present invention is composed of a plurality of devices, a controller which controls the devices, and a portable information terminal connected to the controller through a communicating network, and supports communication setting between the devices and the controller. In the communication setting support system, the controller comprises means for reading first identification information preset for each of the devices, and means for storing the read first identification information. The devices comprise means for accepting third identification information for distinguishing one device from other devices, and third identification information output means for outputting the accepted third identification information to the controller. The portable information terminal comprises means for accepting unique second identification information for identifying the devices, and means for transmitting the accepted second identification information to the controller after the output of the third identification information to the controller by the third identification information output means. The controller further comprises means for storing the transmitted second identification information in association with the stored corresponding first identification information.

According to the above-described invention, the controller reads the first identification information such as an MAC address preset for each device. The controller stores all the read first identification information about the devices. The portable terminal apparatus connected to the controller through the communicating network accepts the unique second identification information for identifying each device. The devices accept the third identification information for distinguishing one device from other devices. The third identification information is, for instance, created by outputting a Hi signal (switching on the power, for example) for only one device and outputting a Lo signal (switching off the power, for example) for other devices.

After outputting the accepted third identification information from one device to the controller, the portable terminal apparatus transmits the accepted second identification information to the controller. Finally, the controller stores the transmitted second identification information in association with the stored corresponding first identification information. With the invention configured as described above, the controller can recognize which device is concerned with the second identification information transmitted from the portable terminal apparatus, based on the third identification information. Moreover, since the use of the portable terminal apparatus eliminates the need to incorporate in each device a keyboard or an infrared port for inputting the second identification information, the manufacturing costs of the devices can be reduced. Furthermore, since the portable terminal apparatus can be freely carried, it is possible to input the second identification information at places near the respective devices while checking the devices, thereby significantly reducing human errors such as incorrect inputs.

The above and further objects and features of the invention will more fully be apparent from the following detailed description with accompanying drawings.

### BRIEF DESCRIPTION OF THE SEVERAL VIEWS OF THE DRAWINGS

FIG. 1 is an explanatory view showing a conventional device identifying method;

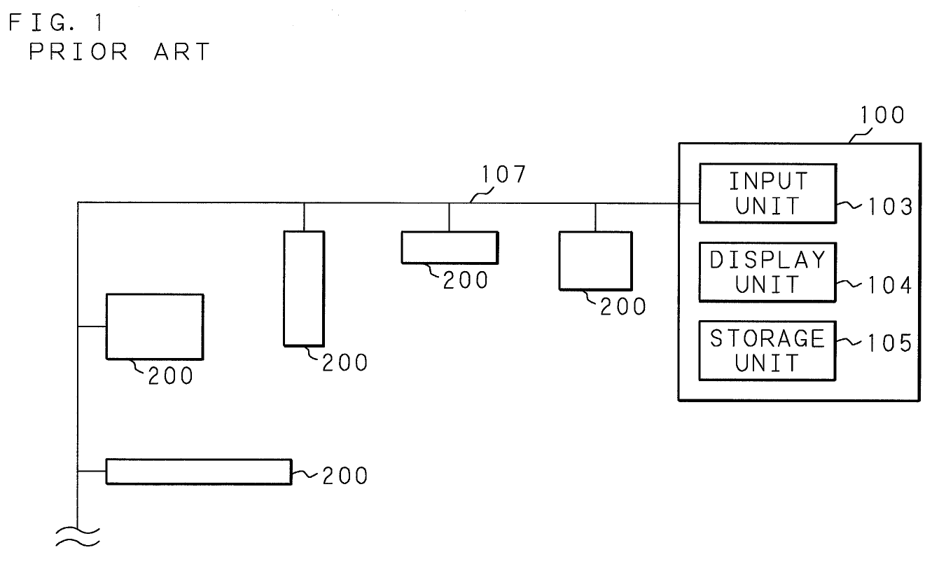

FIG. 2 is an explanatory view showing the record contents in a storage unit;

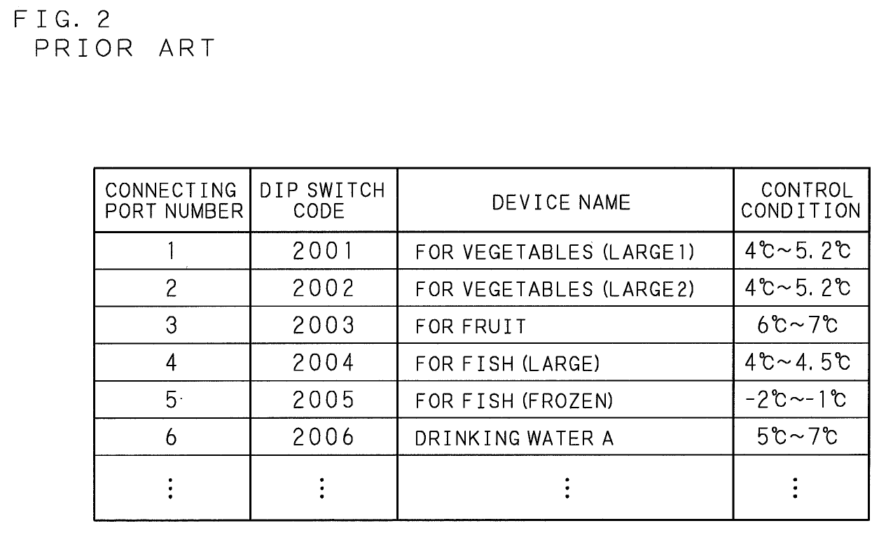

FIG. 3 is a block diagram showing the configuration of a communication setting support system according to the present invention;

FIG. 4 is an explanatory view showing a record layout of a configuration file;

FIG. 5 is a flow chart showing the procedure of a communication setting support method according to the present invention;

FIG. 6 is a block diagram showing the configuration of a communication setting support system according to the second embodiment;

FIG. 7 is a flow chart showing the procedure of a communication setting support method according to the second embodiment of the present invention; and

FIG. 8 is a flow chart showing the procedure of the communication setting support method according to the second embodiment of the present invention.

### DETAILED DESCRIPTION OF THE INVENTION

The following description will explain the present invention in detail with reference to the drawings illustrating some embodiments thereof. Note that although the following description explains the application of the present invention to communication setting between devices and a controller installed in a shop, the present invention is not necessarily limited to this application and may also be applied to communication setting between devices and a controller installed in a facility such as a building, a train, an airplane, and a park.

First Embodiment

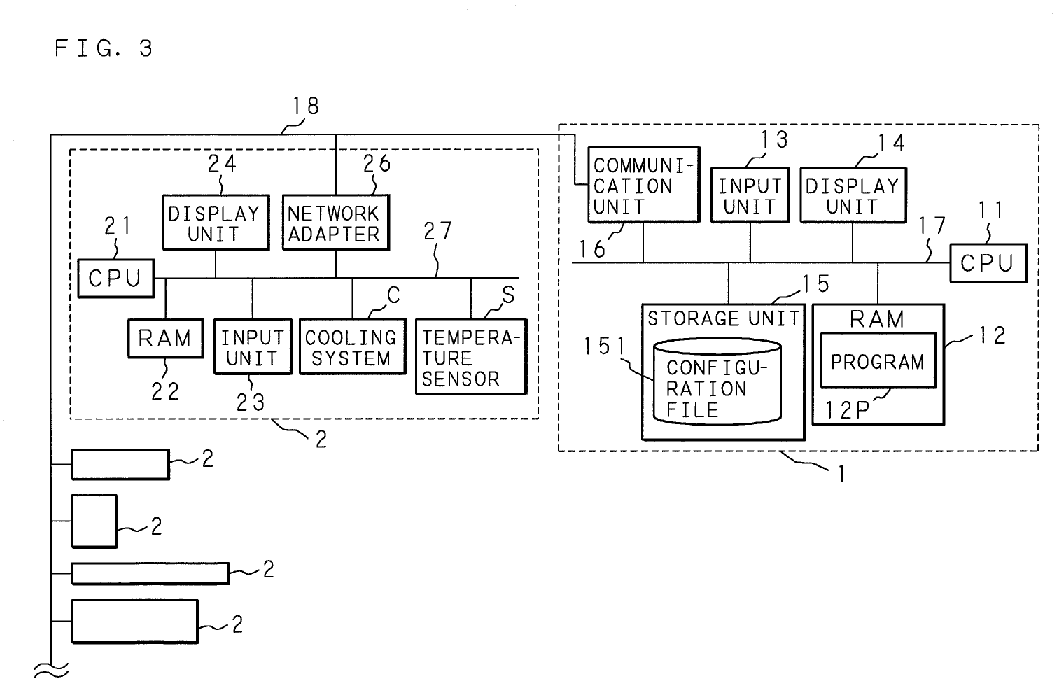

FIG. 3 is a block diagram showing the configuration of a communication setting support system according to the present invention. As shown in FIG. 3, devices 2 are connected to a controller 1 through a communication cable 18. A CPU 11 of the controller 1 is connected through a bus 17 to a RAM 12, a storage unit 15 such as a hard disk, a communication unit 16 for transmitting/receiving information to/from the devices 2, a display unit 14 such as a liquid crystal display, and an input unit 13 such as a keyboard. The RAM 12 stores a program 12P for controlling the storage unit 15, the display unit 14, the input unit 13, etc. The storage unit 15 has a configuration file 151 containing first identification information, second identification information and the like about the devices 2. The contents of the configuration file 151 will be described later.

Each device 2 is a showcase, an air-conditioning system, a vending machine, lighting equipment or a POS terminal apparatus, for example. A network adaptor 26 connected to the communication cable 18 contains the first identification information such as an MAC address for identifying a device 2. When the controller 1 and the device 2 are connected to each other through the network adaptor 26, the controller 1 reads the first identification information (MAC address) about the device 2 stored in the network adaptor 26 by a plug-and-play function, and then stores the first identification information in the configuration file 151 in the storage unit 15. Note that, according to the first embodiment, although the first identification information about the devices 2 is read by the controller 1, the devices 2 may be configured to transmit the stored first identification information to the controller 1. The following description will explain an example of the present invention where the devices 2 are showcases.

Various setting conditions such as the temperature condition inside each device 2 and defrost timing are inputted by an administrator through the input unit 13 of the controller 1. The inputted setting conditions are stored in a RAM 22 of each device 2. Each device 2 has a cooling system C for emitting a refrigerant. Based on the setting conditions stored in the RAM 22, a CPU 21 performs feedback control with respect to the cooling system C so that the temperature outputted by a temperature sensor S is constant. Besides, the CPU 21 is connected thorough a bus 27 to a display unit 24 and an input unit 23 for inputting unique second identification information for identifying the device 2. Note that the input unit 23 may be configured as a push-button system so as to permit the administrator to directly input the second identification information through the input unit 23, or as a communication port such as an infrared port to receive the second identification information inputted through an unrepresented portable terminal apparatus.

The inputted second identification information is outputted to the controller 1 immediately after, or in a suitable timing after, being stored in the RAM 22. The controller 1 stores the outputted second identification information in association with the corresponding first identification information which has already been stored in the configuration file 151.

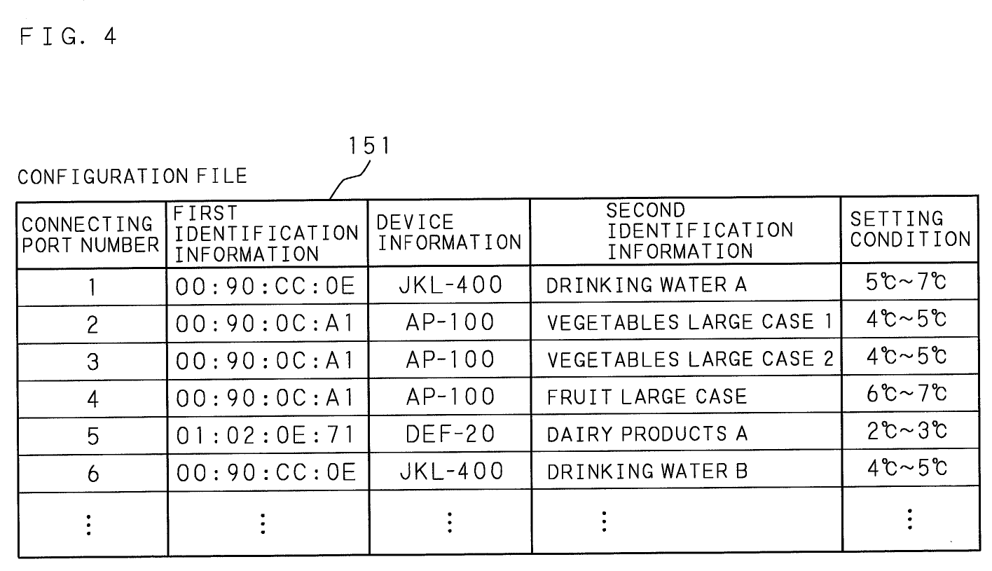

FIG. 4 is an explanatory view showing a record layout of the configuration file 151. In the configuration file 151, the first identification information, the second identification information and the like about the devices 2 are stored in association with the corresponding communication port numbers of the unrepresented communication ports of the communication cable 18. The communication port numbers are numbers given to the unrepresented communication ports fitted into the network adaptors 26 in a sequential order from the upstream side to the downstream side of the connecting cable. The first identification information is the MAC address stored in the network adaptor 26. As the first identification information, a value designated by the IEEE or value designated by a manufacturer for each device 2 is stored. The storage unit 15 contains an unrepresented MAC address table corresponding to the MAC addresses. The MAC address table stores the device name, the manufacture name, and other device information in association with each MAC address. The CPU 11 of the controller 1 extracts the device information with reference to the first identification information (MAC address) read from each device 2 and the MAC address table, and stores the respective information in a device information field in the configuration file 151.

The second identification information is a name uniquely given to each device 2 by a shop administrator or the like through the input unit 23 of the device 2. As shown in FIG. 4, for example, in order to identify the respective showcases, a name corresponding to goods displayed in a showcase is given, or information about the installed position of a showcase such as the “2nd floor, 1st corner vegetable case”, for example, may be added. The administrator can set the device name (second identification information) at a place near the device 2. It is thus possible to prevent human errors such as setting the name of a device 2 for other device 2.

As the setting conditions, the set temperature of each device 2 is stored. The setting conditions are inputted by the administrator through the input unit 13 of the controller 1. As the setting conditions, it is possible to set defrost timing or the like, in addition to the set temperature.

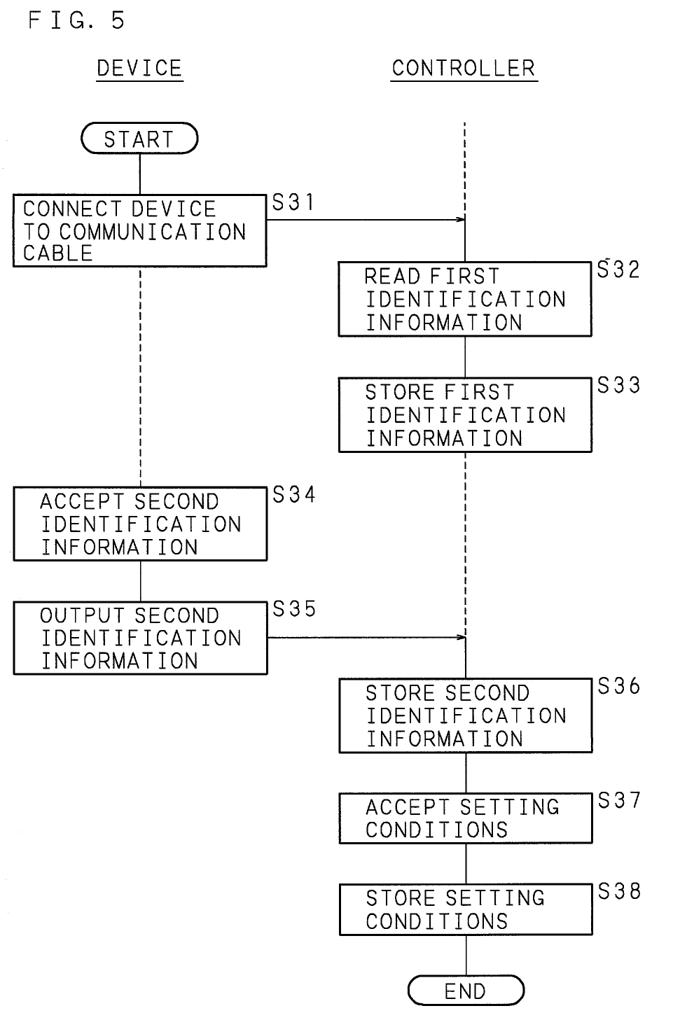

FIG. 5 is a flow chart showing the procedure of a communication setting support method according to the present invention. First, the network adaptor 26 of each device 2 is connected to the communication cable 18 (step S31). The controller 1 reads the first identification information stored in advance in the network adopters 26 of the connected devices 2 by the plug-and-play function (step S32). After reading the information, the controller 1 stores the read first identification information in the configuration file 151 in the storage unit 15 (step S33).

The administrator inputs suitable second identification information through the input unit 23 of the device 2. The device 2 accepts the inputted second identification information (step S34), and stores it in the RAM 22. The device 2 reads the second identification information stored in the RAM 22 in a suitable timing and outputs it to the controller 1 (step S35). Note that, in this embodiment, although the administrator inputs the second identification information through the push-button system or the like of the input unit 23, the present invention is not necessarily limited to this, and the present invention may be configured to have an infrared port (for receiving) as the input unit 23 and the second identification information is inputted through an unrepresented portable terminal apparatus and the inputted second identification information is transmitted from an infrared port (for transmission) of the unrepresented portable terminal apparatus to the infrared port (for receiving) of the input unit 23. In this case, the input unit 23 indirectly accepts the inputted second identification information and outputs it to the controller 1.

The controller 1 stores the outputted second identification information in association with the corresponding first identification information stored in step S33 (step S36). Finally, the administrator inputs the setting conditions, such as the set temperature, for each of the devices 2 through the input unit 13 of the controller 1. The inputted setting conditions are accepted (step S37), and the accepted setting conditions are stored in the configuration file 151 in association with the corresponding first identification information and second identification information (step S38).

Second Embodiment

While the second identification information is inputted using the input unit 23 in the first embodiment, the second embodiment inputs the second identification information using a portable terminal apparatus 3 and transmits the inputted second identification information directly to the controller 1 in a predetermined timing.

Note that the controller 1 may be constructed to store in advance a menu of second identification information. With this construction, the controller 1 transmits the menu to the portable terminal apparatus 3 and the portable terminal apparatus 3 displays a table of the menu. The administrator can select desired second identification information from the displayed table.

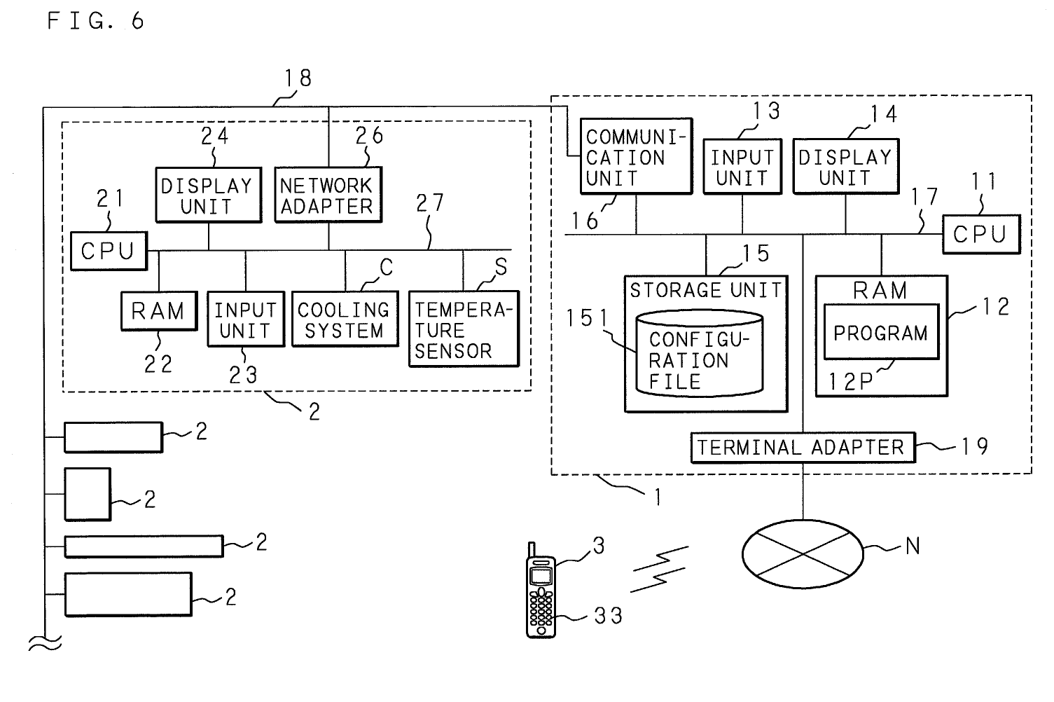

FIG. 6 is a block diagram showing the configuration of a communication setting support system according to the second embodiment. As shown in FIG. 6, a terminal adaptor 19 of the controller 1 is connected through a communicating network N to a portable terminal apparatus 3 such as a cellar phone, a POS terminal apparatus, a PDA device or a notebook-sized personal computer. The portable terminal apparatus 3 includes an input unit 33 such as a push-button system. The administrator inputs the second identification information through the input unit 33 of the portable terminal apparatus 3, and then the inputted second identification information is transmitted to the controller 1 via the communicating network such as the Internet and the terminal adaptor 19.

In the second embodiment, it is necessary to transmit to the controller 1 the information for identifying a device 2 in a group of devices 2, which is concerned with the second identification information transmitted from the portable terminal apparatus 3. Therefore, the administrator inputs third identification information for distinguishing one device 2 from other devices 2 through the input unit 23 of the device 2. The third identification information is created by, for example, switching on the power of the one device 2 while switching off the power of the other devices 2, and outputting the on/off signals to the controller 1. The controller 1 can recognize which device 2 is on at present, and therefore, if the second identification information is transmitted from the portable terminal apparatus 3 in this state, the configuration file 151 stores the second identification information in association with the corresponding first identification information.

As described above, the transmission of the third identification information enables the controller 1 to store the first identification information and second identification information of one device 2 in association with each other. As the third identification information, on/off signals of the lighting switches of the showcases may be used, instead of the power on/off signals. Moreover, outputting of broadcast information to other devices 2 and the controller 1 may be employed as the third identification information.

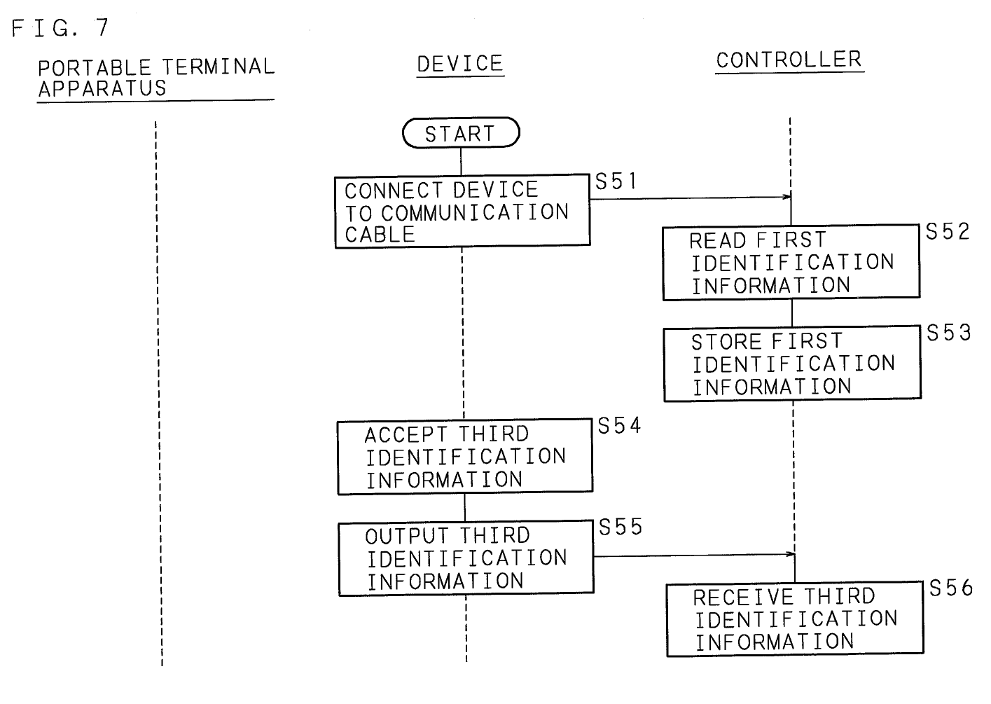

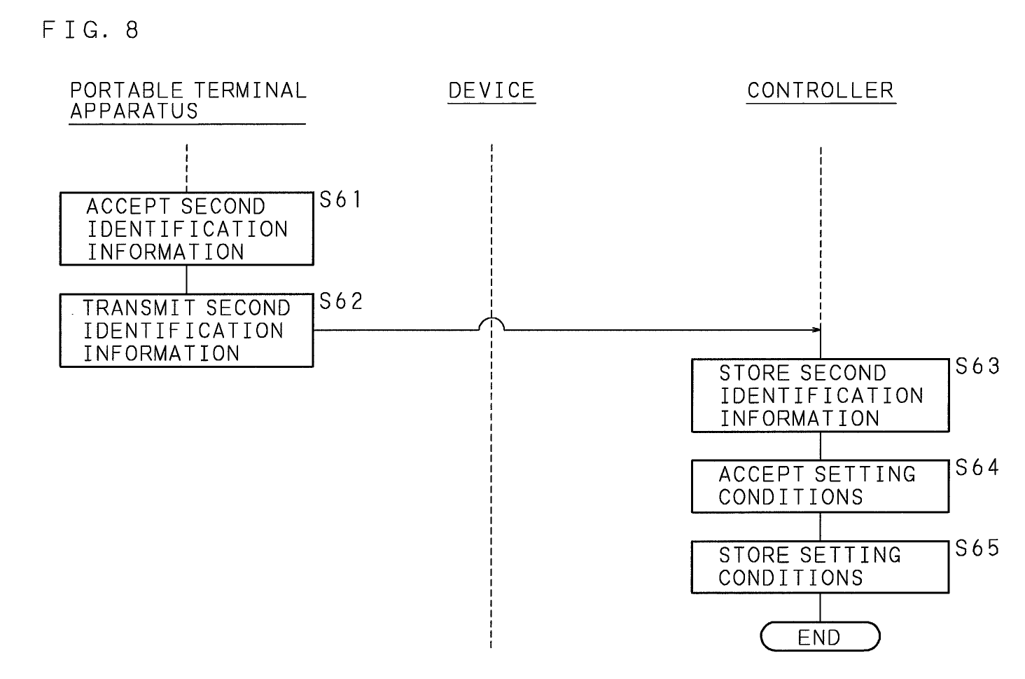

FIGS. 7 and 8 are flow charts showing the procedure of a communication setting support method according to the second embodiment of the present invention. First, the network adaptor 26 of each device 2 is connected to the communication cable 18 (step S51). The controller 1 reads the first identification information stored in advance in the network adopters 26 of the connected devices 2 by the plug-and-play function (step S52). After reading the information, the controller 1 stores the read first identification information in the configuration file 151 in the storage unit 15 (step S53). Subsequently, the third identification information is inputted through the input unit 23 of the device 2, such as the lighting switch. The inputted third identification information is accepted (step S54), and the accepted third identification information is outputted to the controller 1 (step S55).

The controller 1 receives the outputted third identification information (step S56). After receiving the third identification information, i.e., in a state where the controller 1 can distinguish one device 2 from other devices 2, the portable terminal apparatus 3 accepts the second identification information inputted through the input unit 33 (step S61). The portable terminal apparatus 3 transmits the accepted second identification information to the controller 1 (step S62). Since the controller 1 can recognize which device 2 is concerned with the transmitted second identification information based on the third identification information, the controller 1 stores the second identification information in the configuration file 151 in association with the corresponding first identification information (step S63). More specifically, the controller 1 recognizes a corresponding connecting port number by using the third identification information as a key, reads the first identification information corresponding to the recognized connecting port number from the configuration file 151, and stores it in the RAM 12. When the second identification information is transmitted, the controller 1 reads the first identification information stored in the RAM 12, and stores the first identification information and the second identification information in the configuration file 151.

Finally, the administrator inputs the setting conditions, such as the set temperature, for each of the devices 2 through the input unit 13 of the controller 1. The inputted setting conditions are accepted (step S64), and the accepted setting conditions are stored in the configuration file 151 in association with the corresponding first identification information and second identification information (step S65).

The second embodiment is configured as described above. Since other structures and functions of the second embodiment are the same as those of the first embodiment, the corresponding parts are designated with the same reference numbers and the detailed explanation thereof is omitted.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A communication setting support method for supporting setting of a communication characteristic between a plurality of devices and a controller which controls the devices, by storing information for identifying each device in the controller, comprising the steps of:
reading, by the controller, first identification information stored in each of the devices;
storing the read first identification information in the controller;
accepting, by the devices, unique second identification information for identifying each of the devices;
outputting the accepted second identification information from the devices to the controller; and
storing the outputted second identification information in association with the stored corresponding first identification information in the controller.

2. A communication setting support method for supporting setting of a communication characteristic between a plurality of devices and a controller which controls the devices, by storing information for identifying each device in the controller, comprising the steps of:
reading, by the controller, first identification information stored in each of the devices;
storing the read first identification information in the controller;
accepting unique second identification information for identifying each of the devices by a portable terminal apparatus connected to the controller through a communicating network;
accepting, by one device, third identification information for distinguishing said one device from other devices;
outputting the accepted third identification information from the one device to the controller;
transmitting the accepted second identification information from the portable terminal apparatus to the controller after outputting the third identification information; and
storing the transmitted second identification information in association with the stored corresponding first identification information in the controller.

3. A communication setting support system including a plurality of devices and a controller which controls the devices, for supporting setting of a communication characteristic between the devices and the controller by storing information for identifying each device in the controller,
the controller being capable of performing the operations of:
reading first identification information stored in each of the devices;
storing the read first identification information; and
storing unique second identification information for identifying each of the devices in association with the stored corresponding first identification information,
the devices being capable of performing the operations of:
accepting the second identification information; and
outputting the accepted second identification information to the controller.

4. A communication setting support system including a plurality of devices, a controller which controls the devices, and a portable information terminal connected to the controller through a communicating network, for supporting setting of a communication characteristic between the devices and the controller by storing information for identifying each device in the controller,
the controller being capable of performing the operations of:
reading first identification information stored in each of the devices;
storing the read first identification information; and
storing unique second identification information for identifying each of the devices in association with the stored corresponding first identification information,
the devices being capable of performing the operations of:
accepting third identification information for distinguishing one device from other devices; and
outputting the accepted third identification information to the controller,
the portable information terminal being capable of performing the operations of:
accepting the second identification information; and
transmitting the accepted second identification information to the controller after the output of the third identification information from the devices to the controller.

5. A communication setting support system including a plurality of devices and a controller which controls the devices, for supporting setting of a communication characteristic between the devices and the controller by storing information for identifying each device in the controller,
the controller comprising:
means for reading first identification information stored in each of the devices;
means for storing the read first identification information; and
means for storing unique second identification information for identifying each of the devices in association with the stored corresponding first identification information,
the devices comprising:
means for accepting the second identification information; and
means for outputting the accepted second identification information to the controller.

6. A communication setting support system including a plurality of devices, a controller which controls the devices, and a portable information terminal connected to the controller through a communicating network, for supporting setting of a communication characteristic between the devices and the controller by storing information for identifying each device in the controller,
the controller comprising:
means for reading first identification information stored in each of the devices;
means for storing the read first identification information; and
means for storing unique second identification information for identifying each of the devices in association with the stored corresponding first identification information,
the devices comprising:
means for accepting third identification information for distinguishing one device from other devices; and
third identification information output means for outputting the accepted third identification information to the controller,
the portable information terminal comprising:
means for accepting the second identification information; and
means for transmitting the accepted second identification information to the controller after the output of the third identification information from the third identification information output means to the controller.
